(19) United States
(12) Patent Application Publication
(10) Pub. No.: US 2013/0198078 A1
(43) Pub. Date: Aug. 1, 2013

(54) SECURE GRAPHICAL CODE TRANSACTIONS

(71) Applicant: OneID Inc., Redwood City, CA (US)

(72) Inventor: STEVEN TODD KIRSCH, Redwwood City, CA (US)

(73) Assignee: ONEID INC., Redwood City, CA (US)

(21) Appl. No.: 13/745,304

(22) Filed: Jan. 18, 2013

Related U.S. Application Data
(60) Provisional application No. 61/609,848, filed on Mar. 12, 2012.
(60) Provisional application No. 61/609,835, filed on Mar. 12, 2012.
(60) Provisional application No. 61/588,084, filed on Jan. 18, 2012.

(51) Int. Cl. G06Q 20/40

(52) U.S. Cl. CPC G06Q 20/4014
USPC 705/44

(57) ABSTRACT

A method of making a payment using an encoded graphic by a user device may include acquiring an image of the encoded graphic, and determining payment information using information associated with the encoded graphic. The method may also include sending a request to an identity repository for a first signature for the payment. The method may additionally include receiving the first signature for the payment from the identity repository. The method may further include sending the payment information and the first signature to a payment gateway.

### CROSS-REFERENCES TO RELATED APPLICATIONS

This application claims priority to the following three U.S. Provisional Patent Applications, and the entire disclosure of each of these applications are incorporated by reference into this application for all purposes:
U.S. Provisional Patent Application No. 61/609,848, filed Mar. 12, 2012 entitled “Methods and Systems for Secure Identity Management” (Attorney Docket No. 94276-833770(000400US));
U.S. Provisional Patent Application No. 61/609,835, filed Mar. 12, 2012 entitled “Method and System for Secure Quick-Response Code Purchases”, (Attorney Docket No. 94276-832681(000100US)); and
U.S. Provisional Patent Application No. 61/588,084, filed Jan. 18, 2012, entitled “Single Identification for Transactions” (Attorney Docket No. 94276-840013(001300US)).

The following five regular U.S. patent applications (including this one) are being filed concurrently, and the entire disclosure of the other applications are incorporated by reference into this application for all purposes:
U.S. patent application Ser. No. ______, filed Jan. ______, 2013, entitled “Methods and Systems for Secure Identity Management” (Attorney Docket No. 94276-840939(000410USNP));
U.S. patent application Ser. No. ______, filed Jan. ______, 2013, entitled “Methods and Systems for Pairing Devices” (Attorney Docket No. 94276-847941(000710USNP));
U.S. patent application Ser. No. ______, filed Jan. ______, 2013, entitled “Methods and Systems for Device Disablement” (Attorney Docket No. 94276-849686(001010USNP));
U.S. patent application Ser. No. ______, filed Jan. ______, 2013, entitled “Secure Population of Form Data” (Attorney Docket No. 94276-861349(000910US)); and
U.S. patent application Ser. No. ______, filed Jan. ______, 2013, entitled “Secure Graphical Code Transactions” (Attorney Docket No. 94276-832681(000110US)).

### BACKGROUND

Personal computing devices have becomine an important part of the retail landscape. Smart phones, tablet computers, laptops, and personal computers are being used by large segments of the population to engage in retail, banking, and communication transactions. By necessity, these transactions require identity verification and communication security in order to avoid compromising sensitive data. Therefore, sensitive data has to either be remembered by a user or stored somewhere on a computing device. Sensitive data is often lengthy and complicated, and thus, it is unwieldy for users to be expected to remember and enter this information reliably.

Just as personal computing devices have recently gained popularity for engaging in secure transactions, attackers and malware creators have seized on this fertile new ground for criminal purposes. Users often have viruses and other types of malware operating on their user devices without their knowledge. These malicious software processes can often compromise the widespread use of specialized banking and communication software to gain access to personal information. This personal information can be transmitted to a distant location and exploited long before users know their data has been compromised.

One particular vulnerability of online transactions may arise when customers pay bills using computing devices. These transactions may involve many unsecured procedures, such as receiving a bill in the mail, signing checks that include bank account numbers and routing numbers, sending checks in the mail, populating online forms with personal information, providing credit card information over the Internet, and/or the like. Each of these transactions is vulnerable to eavesdroppers, man-in-the-middle attacks, mail theft, keyboard logging, and a host of other malicious activities. Despite these vulnerabilities, payment transactions between two parties that are geographically separated continue to increase. Therefore improvements are needed in the art.

### BRIEF SUMMARY

The present invention relates generally to online, or virtual identities. More specifically, the present invention relates to methods and systems for using virtual identities to complete transactions using an encoded graphic. Merely by way of example, the invention has been applied to a method of securely completing a transaction by scanning an encoded graphic and using an identity repository to complete the transaction. The methods and techniques can be applied to a variety of transactions, interactions, and identity management systems.

According to one embodiment, method of making a payment using an encoded graphic by a user device may include acquiring an image of the encoded graphic, and determining payment information using information associated with the encoded graphic. The method may also include sending a request to an identity repository for a first signature for the payment. The method may additionally include receiving the first signature for the payment from the identity repository. The method may further include sending the payment information and the first signature to a payment gateway.

In some embodiments, the method may also include providing, by the user device, a second signature for the payment, and sending the second signature to the payment gateway. The method may additionally include receiving a payment method, where the payment information may include the payment method. The method may further include accessing product option types for a product being purchased, sending the identity repository a request for product option selections, and receiving the product option selections from the identity repository, where the payment information may include the product option selections. Determining payment information using the information associated with the encoded graphic may include decoding a merchant identifier from the encoded graphic, and using the merchant identifier to retrieve a payment amount, where the payment information comprises the payment amount. Also, determining payment information using the information associated with the encoded graphic may include decoding an invoice identifier from the encoded graphic, and using the invoice identifier to retrieve the payment amount.

In some embodiments, the encoded graphic may comprise a Quick Response (QR) code. The first signature may indicate that the identity repository has verified an identity of the user device. The identity repository may be authorized to release an account number for the payment method. The product option types may be decoded from the encoded graphic. The payment information may be sent to the payment gateway through the identity repository.

In another embodiment, a method of authorizing a payment involving an encoded graphic by an identity repository may include receiving a request for a first signature for the payment from a user device. The method may also include verifying an identity of the user device and sending the first signature to the user device. The method may additionally include receiving a request for an account number, and providing the account number for the payment.

In some embodiments, the method may also include receiving product option types for a product being purchased, and providing product option selections corresponding to the product option types, where the product option selections may be stored in an encrypted form at the identity repository. The method may additionally include receiving a signed challenge from the user device in order to verify the identity of the user device. The method may further include receiving a merchant identifier from the user device where the merchant identifier may be decoded from the encoded graphic, retrieving payment information using the merchant identifier, and sending the payment information to the user device.

In some embodiments, the request for the account number may include a second signature that may be signed by the user device. The account number may be provided to a payment gateway. The product option selections may previously be provided to the identity repository by the user device. The identity repository may be geographically remote from the user device, the identity repository may store information provided by the user device in an encrypted form, and a decryption key associated with the information provided by the user device might not be stored in the identity repository.

In yet another embodiment, a computer-readable memory comprising a sequence of instructions may be presented. The instructions, when executed by one or more processors, may cause the one or more processors to make a payment using an encoded graphic by acquiring an image of the encoded graphic, determining payment information from the encoded graphic, sending a request to an identity repository for a first signature for the payment, receiving the first signature for the payment from the identity repository, and sending the payment information and the first signature to a payment gateway.

Numerous benefits can be achieved by way of the present invention over conventional techniques. For example, embodiments of the present invention reduce the likelihood that malicious actors can intercept form data during a transaction. Additionally, embodiments of the present invention provide a system for reducing errors and inconveniences that may be introduced during manual information entry. Also, large amounts of information necessary to a transaction may be encapsulated in an encoded graphic and thus may be included in a transaction without requiring a user to read and understand all of the information. These and other embodiments along with many of their advantages and features are described in more detail in conjunction with the text below and attached figures.

### BRIEF DESCRIPTION OF THE DRAWINGS

A further understanding of the nature and advantages of the present invention may be realized by reference to the remaining portions of the specification and the drawings, wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIG. 1 illustrates a simplified block diagram of an exemplary identity management system, according to one embodiment.

FIG. 2 illustrates a simplified block diagram of key storage for an identity management system, according to one embodiment.

FIG. 3A illustrates a simplified example of an encoded graphic code used in a payment, according to one embodiment.

FIG. 3B illustrates another simplified example of an encoded graphic used in a payment, according to one embodiment.

FIG. 4 illustrates a simplified block diagram of a payment system using an identity repository, according to one embodiment.

FIG. 5 illustrates a simplified block diagram for accessing payment information, according to one embodiment.

FIG. 6 illustrates a simplified block diagram for specifying product option selections, according to one embodiment.

FIG. 7 illustrates a simplified flow diagram of transactions involving an encoded graphic, according to one embodiment.

FIG. 8A illustrates a simplified flowchart of a method of making a payment involving an encoded graphic by a user device, according to one embodiment.

FIG. 8B illustrates a simplified flowchart of a method of authorizing a payment involving an encoded graphic, according to one embodiment.

FIG. 9 illustrates a block diagram of components for an exemplary operating environment in which various embodiments of the present invention may be implemented.

FIG. 10 illustrates a block diagram of an exemplary computer system in which embodiments of the present invention may be implemented.

### DETAILED DESCRIPTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “ machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Described herein, are embodiments for making a payment using an encoded graphic. In some embodiments, a user device may acquire an image of the encoded graphic and decode information therefrom. For example, a merchant identifier, an invoice number, a payment amount, and/or other information may be decoded from the encoded graphic. The decoded information may be supplemented with information stored at the merchant, the user device, the identity repository, or a payment gateway. A digital signature may be acquired from the identity repository as well as the user device, and the signatures and payment information may be transmitted to a payment gateway for eventual payment to the merchant.

This disclosure is divided into three sections. First a basic overview of a secure identity management system will be provided. This secure identity management system can be used to store sensitive information away from a user device and provide that information when needed to complete a transaction using an encoded graphic. Next, exemplary embodiments of the present invention will be presented. These embodiments will illustrate how to use an encoded graphic to complete a transaction utilizing an identity repository. Finally, an exemplary hardware system will be provided comprising network computing devices that can be used to implement the various embodiments disclosed herein.

### Secure Identity Management

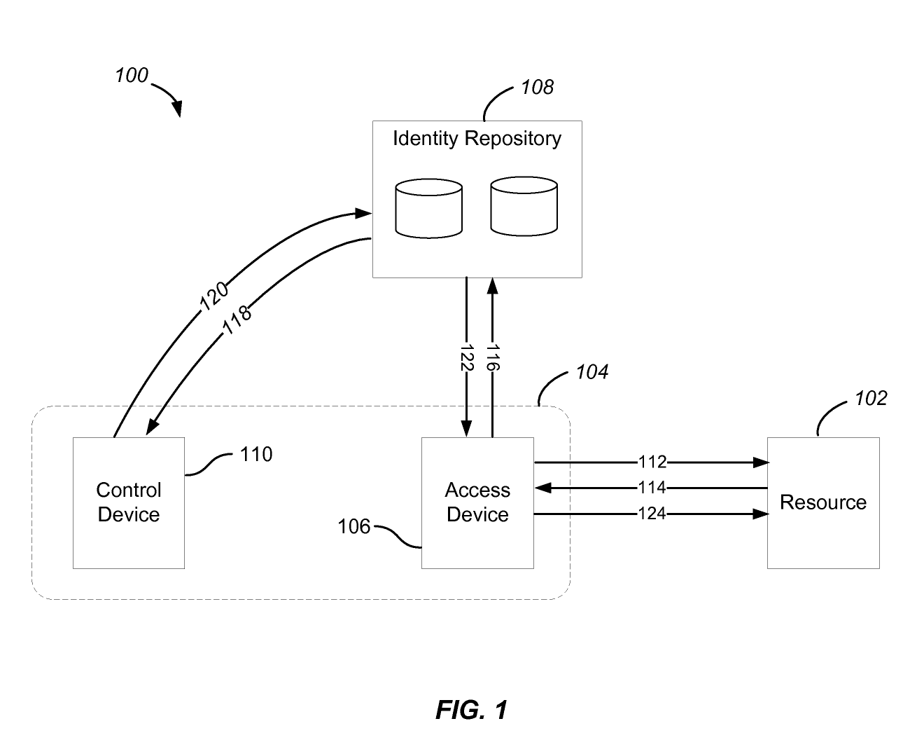

FIG. 1 illustrates a simplified block diagram 100 of a system for online identity management, according to an embodiment of the present invention. The system may be configured to use one or two user devices. At its most basic level, the system can use an access device 106. The access device 106 will typically be the device the user is using for an interaction. Second, an optional control device 110 may be used. The control device 110 may comprise a personal device, such as a smart phone, tablet computer, personal computer, and/or personal digital assistant (PDA) that is controlled by the user. Additionally, a remotely located identity repository 108 can be used in the interaction. The access device 106 can engage in the interaction with a resource 102. The resource can include a website, a database, a web service, and/or the like. Man-in-the-middle attacks can be reduced because cryptographic secrets can be transferred from user controlled endpoint devices securely, even if the identity repository is compromised by an attacker.

In this embodiment, the access device 106 (AD) may comprise a user device that is being authenticated to perform a transaction using a virtual identity. The control device 110 (CD) may comprise a second user device in the user's control that is used to set access rights for the users access device 106 and to perform OOB authentication/verification. The resource 102 (RP) may be defined as a party, typically a website, to which the user wishes the virtual identity to be authenticated and, optionally, with which to share attributes and perform additional transactions. The identity repository 108 (Repo) may be defined as an online database of encrypted credentials and attribute/value pairs. The identity repository 108 may be remotely located and may be operated by a third party that is not associated with either the user or the resource 102. Each access device 106 and control device 110 may have a unique identifier, referred to as a Device ID (DEVID). Additionally, each user may have a unique identifier, or Global User ID (GUID), that is stored on the access device 106 and on the control device 110 and can be used to index information stored on the identity repository 108. Finally, each user may have a second user identification (UID) that comprises a site-specific identifier for the user for the resource 102. The UID can be derived at least in part from the fully-qualified domain name associated with the resource 102.

In one embodiment, the access device 106 and the identity repository 108 can be required in order to complete a transaction. The control device 110 can be a separate device from the access device 106, or the same physical device can be used as both the access device 106 and the control device 110. For example, a laptop can function as both the access device 106 and the control device 110. A mobile phone could also function as both devices. Participation by the control device 110 may optionally be required in a transaction to provide a higher level of assurance that the user has consented to the transaction. This process will be described further below. At any time, the user may choose to use a higher security mode comprising a higher level of assurance. The user can also choose to lock out any individual device or force the individual device into a higher security mode. These actions can be performed on any device registered by the user. Furthermore, some embodiments may employ a special “tripwire” feature so that, if a password or PIN is not entered when requested, a device will be prevented from supplying any subsequent digital signatures until the requested password or PIN is provided.

As used herein, transactions may use a varying “Level of Assurance” (LoA) mode. In one embodiment, four modes are supported: disabled, enabled with no security, password with a timeout, and out-of-band (OOB) authorization required with an optional PIN and timeout. Users can control the LoA mode required by each type of transaction. To minimize risk in the case of a lost user device, devices can be immediately turned off from any remaining registered device that the user still controls. In one embodiment, the identity repository 108 can enforce the greater of two LoA modes: the level requested by the user and the level requested by the resource 102. This can ensure that organizations, such as financial institutions, can be compliant with regulations regardless of the security level requested by the user. For example, a bank could require that, for transaction to be approved, a PIN should be entered on the control device 110 within a time period, such as 5 minutes. For banks, two factor authentication may be required by FFIEC regulations.

According to one embodiment, the conditions in an LoA mode may be based on information related to the devices owned or operated on behalf of the user or devices authorized for the user with limits on how devices can be used in the transaction. For example, a desktop computer in a secure work area may have a higher transaction value limit than a mobile device. A mobile device with a password-to-unlock feature may have a higher transaction value limit than an unlocked mobile device. One of ordinary skill in the art would recognize many variations, modifications, and alternatives.

The conditions in an LoA mode can include information related to preferences established by one of the parties, including transaction value limits, time periods during which transactions are initiated, geographic locations where the transaction is initiated, histories of returns or invalidated transactions, user reputations, number of transactions within a particular time period, or the like. The conditions in an LoA mode can also include cumulative data, including thresholds for the number of items in a single purchase, cumulative costs of items in a single transaction, cumulative amount spent in a particular time period, and/or the like. Therefore, the conditions in an LoA mode can comprise a cost threshold for a single transaction, a cumulative cost threshold for transactions during a time period, or a time limit since a password was provided to a user device. These conditions can be used to define almost every aspect of a transaction/interaction, such that a party can set specified authentication levels that add security to high-value transactions or transactions where the risk of fraud is high. It should be noted that if preferences received from a party contradict preferences already stored on the device executing this method, the more conservative or secure preferences can be used in the transaction.

According to one embodiment, the conditions in an LoA mode may also include conditions related to types of transactions. For example, purchasing certain types of goods, such as jewelry, cars, software, collectibles, or the like, that are more likely to be involved in theft and fraud can require higher levels of authentication. The conditions can also include conditions on payment options. For example, purchasing items with a credit card may require a first authorization level, while paying for items with a debit card may require a second authorization level. The preferences can also include conditions on methods of shipping or shipping locations. For example, shipping items to a Post Office Box or to an address different from the billing address may require a higher authorization level.

Each of the conditions of an LoA mode may be associated with one or more authentication levels. If the condition is met, then the specified authentication level (or a higher authentication level) should be used in the transaction/interaction. An authentication level can comprise requiring an indication that the transaction is approved to be received by a user module operating on a user device. For example, a user may be required to provide input indicating that they have reviewed the transaction and approve. An authentication level can also comprise notifying additional devices that are associated with the user. For example, a notification can be sent to a user's cell phone or tablet computer for a transaction that was initiated on the user's desktop computer. An authentication level can comprise requiring a PIN or password to be received by one or more of the additional devices associated with the user, such as a control device. An authentication level can comprise a waiting period between initiating the transaction and final approval. In one embodiment, an authentication level may require human contact by a representative of the relying party. In another embodiment, an authorization level can require a third-party to authenticate the transaction, such as the identity repository.

In one embodiment, an LoA mode can also specify a timeout period associated with each PIN and/or password. For example, one mode could specify that a password should be entered into the access device within the last three hours preceding the transaction/interaction. As another example, one mode could specify that a PIN should be entered into the control device within five minutes preceding the transaction interaction. The timeout period may be affected by other factors, such as the time of day of the transaction, a cost associated with the transaction, the security of the device used in the transaction, a cumulative cost of a set of transactions, and/or any other factors described above. For example, a timeout period may be longer on a secure device, whereas the timeout period may be shorter on an insecure device.

What follows is a brief description of one exemplary transaction. Each step in this exemplary transaction will be discussed in more detail later in this disclosure. Returning to block diagram 100 of FIG. 1, the access device 106 can access the resource 102 (112). In response, the resource 102 can return a random digital challenge and request that the access device 106 return the challenge signed by two or three signatures (114). Next, the access device 106 can generate one or more cloud repository keys. The access device 106 can pass the digital challenge and the one or more cloud repository keys to the identity repository 108 (116). If the access device 106 is password protected and a timeout period is exceeded, the user may supply digital proof that the user knows the password to the access device 106. The digital proof may comprise a guess of the password. In one embodiment, the digital proof is not transmitted off of the access device 106, not even in a hashed or encrypted form. Confirmation that the user knows the password is provided by signing a challenge from the identity repository 108.

The identity repository 108 can compare a first LoA mode specified by the access device 106 with a second LoA mode specified by the resource 102 to determine whether an OOB approval should also be required for the transaction. If an OOB approval is determined to be required by either the access device 106 or the resource 102, the identity repository 108 sends a challenge to the control device 110 (118). In one embodiment, certain details of the original transaction can be displayed to the user on the control device 110, thus eliminating the possibility of a man-in-the-browser attack or a man-in-the-middle attack. A PIN can also be requested by the control device 110. If a PIN has not been provided within a timeout period, the control device 110 may prompt the user to enter the PIN. In one embodiment, any PIN guess entered by the user never leaves the control device 110. Instead, the control device 110 can rely on asymmetric cryptography and another challenge from the identity repository 108 to prove to the identity repository 108 that the user has supplied the correct PIN. This process will be described further later in this disclosure. Approval for the transaction, along with any signed challenges, can be sent back to the identity repository 108 (120). In one embodiment, the control device 110 signs the challenge from the resource 102 using a private key stored on the control device 110.

The identity repository 108 can enforce the LoA mode on the transaction. Therefore, the identity repository 108 can withhold its signature on the challenge unless all of the requirements of the LoA mode have been met. If the identity repository 108 determines that all of these requirements have been met, the identity repository 108 can sign the challenge using its private key. The identity repository 108 can then send the signature of the control device 110 and the signature of the identity repository 108 to the access device 106 (122). At this point, the access device 106 can sign the challenge and return all two/three signatures to the resource 102 (124). Additionally, the access device 106 can send a user ID (the site-specific user ID). The resource 102 can look up a set of public keys that are associated with the UID to verify that all three signatures correspond to the public keys and grant access to the user. In one embodiment, the public keys can be unique to the resource 102. In other words, each website will be associated with its own set of public and private key pairs. This can assure a user's privacy and prevent website tracking Because the resource 102 interacts with the access device 106, the identity repository 108 can be prevented from determining which resources the user has visited. The identity repository 108 simply holds an encrypted block of data and receives commands to read and write encrypted keys and values.

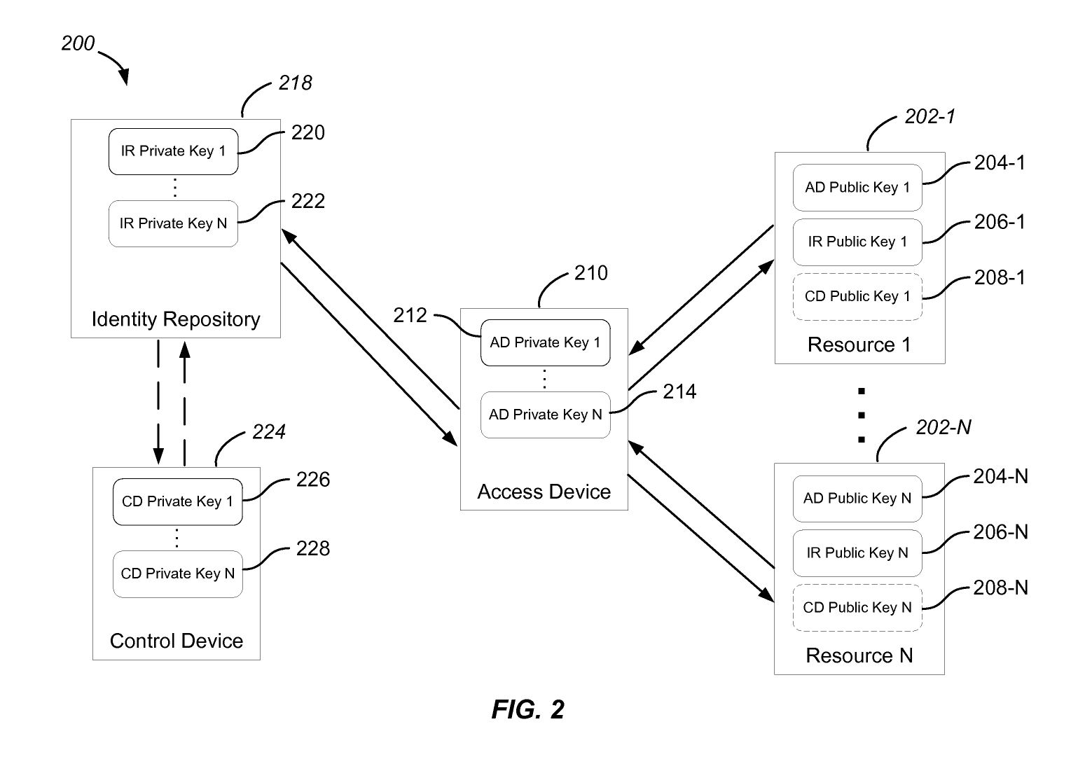

FIG. 2 illustrates a simplified block diagram 200 of a system for online identity management with distributed secrets, according to an embodiment of the present invention. The embodiment of FIG. 2 uses a subset of the keys that may be used by various embodiments of the identity management system. Note that the remaining keys may be operative in the background of the system illustrated by FIG. 2. Additionally, the keys in FIG. 2 may be derived from one or more of the keys not explicitly shown in FIG. 2. As described earlier, an access device 210 may engage in a transaction with a number of resources 202. Each of the resources 202 may have a set of public keys associated with a UID of a user of the access device 210. For example, resource 202-1 stores two to three public keys for the UID 210, namely an AD public key 204-1 that is associated with the access device 210, an IR public key 206-1 that is associated with an identity repository 218, and, optionally, a CD public key 208-1 that is associated with a control device 224.

When the access device 210 first attempts a transaction with one of the resources 202, the access device 210 can provide the public keys 204, 206, 208 to the resources 202. Each of the resources 202 may have a unique set of public keys. In providing the public keys 204, 206, 200, the access device 210 may create the AD public keys 204, and the IR public keys 206 and the CD public keys 208 can be obtained from the identity repository 218 and the control device 224, respectively.

When initiating a transaction, the resources 202 can send a digital challenge to the access device 210 to authenticate a virtual identity. When the LoA mode requirements of each device of been met, each device may sign the digital challenge using the private keys that correspond to the public key of the particular resource. For example, a digital challenge sent from resource 202-1 could be signed by the access device 210 using AD private key 212 and the identity repository 218 using the IR private key 220. Optionally, the digital challenge could also be signed by the control device 224 using the CD private key 226. Each of these devices may enforce one or more requirements of the LoA mode before signing. For example, the control device 224 may require a PIN from the user, and the identity repository 218 may require an OOB authorization from the control device 224. The access device 210 may require a signature from the identity repository 218 as well as a signature from the control device 224 before signing the digital challenge. Other embodiments may enforce different requirements as described elsewhere herein.

In one embodiment, each of these keys are actually stored on their respective devices. In another embodiment, a master key is stored and each device from which the keys in FIG. 2 are deterministically derived when they are needed. For example, the AD private key 212 may be derived from an Access Device Key (ADK) for the access device 210.

The “transactions” referred to in the above discussion should be interpreted broadly. In some cases, a transaction may involve a commercial purchase. In other cases, a transaction may simply involve retrieving securely stored information from the identity repository and decrypting the information at the user device for use by the user device, such as completing a transaction using a graphical code. A full description of the identity management system can be found in U.S. patent application Ser. No. ______, filed concurrently on Jan. ______, 2013, entitled “Methods and Systems for Secure Identity Management” (Attorney Docket No. 94276-840939(000410USNP)), which is incorporated by reference for all purposes as stated above.

### Transactions Involving an Encoded Graphic

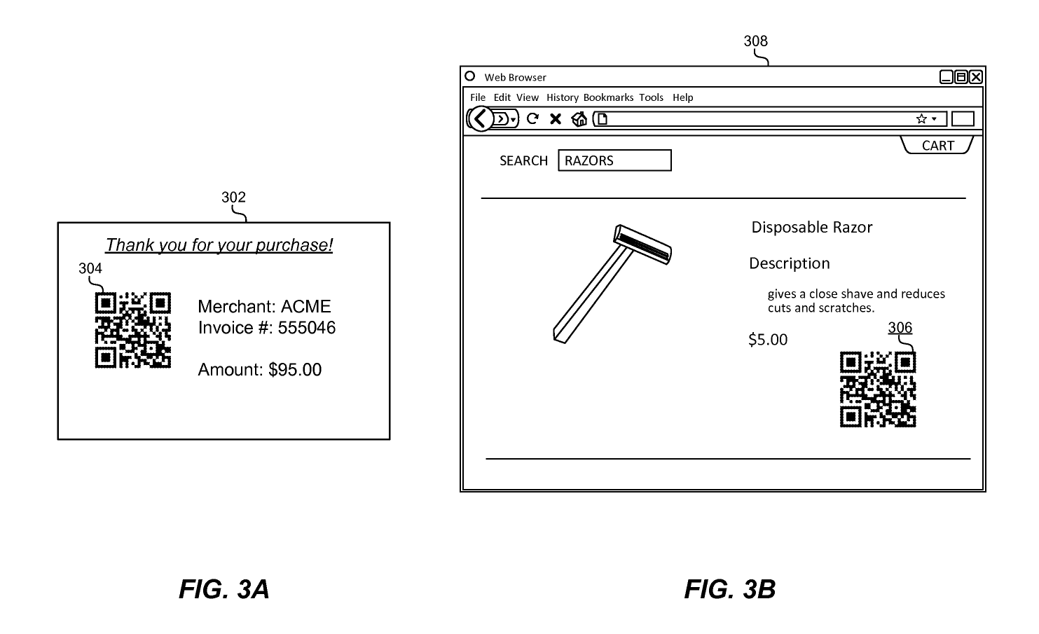

FIG. 3A illustrates a simplified example of an encoded graphic used in a payment, according to one embodiment. In this embodiment, a bill 302 may be sent to a user that includes an encoded graphic 304. The bill 302 may also take the form of an invoice, a product slip, or any other tangible indication that a payment may be due. For example, the bill 302 may be sent to the user through the mail or as a PDF.

The encoded graphic 304 in this particular embodiment takes the form of a quick response (QR) code. A QR code is a graphic symbol comprised of black modules arranged in a square pattern on a white background. Information may be included in the QR code that may be used in a wide range of applications to identify products and services, including commercial tracking, entertainment, transport ticketing, and may be used to replace product bar codes. Modern handheld mobile devices may be used to read a QR code and retrieve information over a network regarding a product or service. In these cases the QR code may represent a Uniform Resource Identifier (URI), and may appear in magazines, on signs, on business cards, and/or on computer or television screens. It will be understood that a QR code is one type of encoded graphic. In this disclosure, any exemplary QR code may be replaced by any other type of encoded graphic.

By including the encoded graphic 304 on the bill 302, a recipient of the bill may use a computing device to acquire an image of the encoded graphic 304. For example, a recipient could scan a QR code using a smart phone. Some embodiments described herein may present an application operating on a user device that can use the information stored in the encoded graphic 304 to initiate and possibly complete a payment transaction. This process may eliminate a need for a user to visit a merchant website and make a purchase, to visit a website and make a payment, or to write a check to be sent in the mail.

FIG. 3B illustrates another simplified example of an encoded graphic used in a payment, according to one embodiment. In addition to providing an encoded graphic 304 on a bill 302, an encoded graphic 306 may be presented as part of an advertisement. In this particular embodiment, the advertisement may take the form of a webpage 308 viewable by a computing device. In other embodiments, the advertisement may take the form of a television commercial, a magazine advertisement, a newspaper advertisement, a mail flyer, a placard, a pinup, a leaflet, a handbill, a billboard, and/or the like.

Using an advertisement, retailers and product manufacturers may provide QR codes containing purchasing and/or product information in advertisements for their products. For example, an advertisement in a magazine may include a QR code that when read by a handheld device may provide a user with additional information for the products. Thus, QR codes read by handheld devices may quickly provide a user with more information than was contained in the original advertisement in an attempt to induce the user to purchase the associated products.

Although QR codes may quickly provide additional information to a user, they typically have not made the process of actually purchasing the products any easier. Typically, the user is simply taken to a webpage where the product may be purchased. Scanning a QR code does not provide the retailer with any personal information from the user that could make the transaction smoother. No names, addresses, or payment information are transmitted by scanning a QR code. Therefore, prior to this disclosure, a user must provide all of this information manually to the retailer after the QR code is scanned in order to complete a purchase. Such a cumbersome process may discourage users from following through with a purchase. The prospect of transmitting confidential payment information from a handheld device may be a daunting task for those who are less technically savvy.

According to embodiments disclosed herein, methods and systems may be disclosed for using an encoded graphic to make a payment as part of a product purchase. The user may scan the encoded graphic with the user device, and decode information stored therein. In some cases, product option types, such as sizes, colors, configurations, and/or the like, may be associated with a particular product. The user device can query an identity manager, and retrieve personal information stored at the identity manager to select a value for each product option type. Additionally, a payment method may be retrieved from the identity repository in order to complete the purchasing information. The purchasing information may then be signed by the identity repository and/or the user device and sent to a payment gateway to complete the transaction.

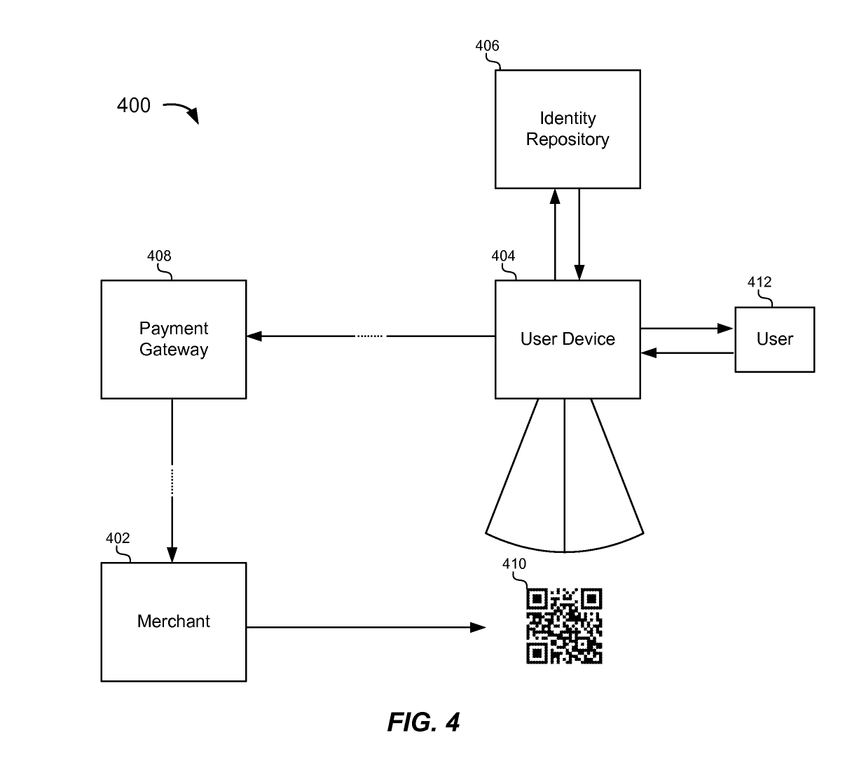

FIG. 4 illustrates a simplified block diagram 400 of a payment system using an identity repository, according to one embodiment. A merchant 402 may encode information in an encoded graphic 410. The encoded graphic 410 may be presented to a user in the form of a bill, an advertisement, a television commercial, a movie preview, and/or any other form that would allow a user to acquire an image of the encoded graphic 410 with a computing device.

Different types of information may be stored in the encoded graphic 410. In embodiments where the encoded graphic 410 is part of a bill, a merchant identifier, an invoice number, a payment amount, due dates, a purchased product, and/or the like may all be encoded in the encoded graphic 410. In embodiments where the encoded graphic 410 is part of an advertisement, information such as a product number, product option types, a merchant URI, a purchase price, discount options, and/or the like may also be stored in the encoded graphic 410.

A user device 404 may acquire an image of the encoded graphic 410. In some embodiments, the user device 404 may comprise a smart phone, a tablet computer, a PDA, a laptop computer, desktop computer, a camera, video camera, and/or the like. Often, the user device 404 may include a camera, and an image of the encoded graphic 410 may be acquired using the camera of the user device 404. Other user devices may include a barcode reader, an infrared scanner, and other types of input devices that may be used to acquire image of the encoded graphic 410. As used herein, the term image need not be limited to a photograph, but may include any digital representation of the image, such as a binary number associated with a barcode.

In some cases, the information retrieved from the encoded graphic 410 may not be sufficient to make a payment, and additional information may be needed. In these cases, a user 412 may supply additional information to the user device 404. Additionally or alternatively, the user device 404 may query an identity repository 406 for additional information related to the purchase. As used herein, the term payment information may be interpreted broadly to include any information that may be used by a merchant to process a payment from the user. This may include a payment amount, an invoice number, a product number, product option selections or values, and/or any other type of information that may be useful to a merchant when processing a payment. The payment may be due to a purchase previously made for which a bill was received, or may be due to a purchase made at approximately same time as the payment was initiated by the user as part of the same transaction.

In some embodiments, payment information may also include information related to a payment method. For example, a payment method may include a credit card number, a bank account number, a debit card number, an expense account number, or any other type of account number that may be associated with a payment account. For these embodiments, a credit card number may be stored at the identity repository 406 in an encrypted form, and may be transferred to the user device 404 to be included in the payment information. Along with the account number, the identity repository 406 may provide a signature using an identity repository private key.

In some embodiments, a payment method may be retrieved from the identity repository 406 instead of an account number associated with the payment method. In these embodiments, the identity repository 406 may also provide a signature using an identity repository private key that may be sent along with the payment method. The signature may be used by a payment gateway or by a merchant to verify that the identity repository has approved the use of the particular payment method in the transaction. The payment gateway and/or the merchant may then request the account number from the identity repository by sending the signed payment information.

After the payment information has been determined by the user device 404, possibly including information retrieved from a user 412 and/or the identity repository 406, the user device 404 may provide another signature using a user device private key for the payment information. In some embodiments, the second signature from the user device may not be necessary, while in some embodiments, the second signature from the user device may be required by the identity repository 406 and/or the merchant 402. The payment information and the signature(s) from the user device 404 and the identity repository 406 may then be sent to the payment gateway 408 so that the transaction may eventually be completed. In some embodiments, the payment information and signatures may be sent to the payment gateway 408 by way of the identity repository 406. In some embodiments, the payment information and signatures may be sent to the payment gateway 408 by way of the merchant 402.

The payment gateway 408 may then process the payment as an ACH transaction, a credit card transaction, and/or the like, and may send the transaction payment to the merchant 402. In some cases, the payment gateway 408 can verify the signatures on the payment information using public keys associated with the user device 404 and/or the identity repository 406. Verifying the signatures may authenticate that the payment information is valid from the user device 404. In some embodiments, the payment gateway 408 may also request an account number associated with the payment method included in the payment information from the identity repository 406. The identity repository 406 may send the account number to be payment gateway 408.

In some embodiments, the identity repository 406 may be a fully encrypted repository. The private key used to decrypt information stored on the identity repository 406 may not be located at the identity repository 406. Instead, the private key used to decrypt the information may be stored on the user device 404. In these cases, the user device 404 may request the encrypted account number from the identity repository 406, decrypt the account number using the private key stored on the user device 404, encrypt the account number as part of a secure communication between the user device 404 and the payment gateway 408, and securely send the account number to the payment gateway 408.

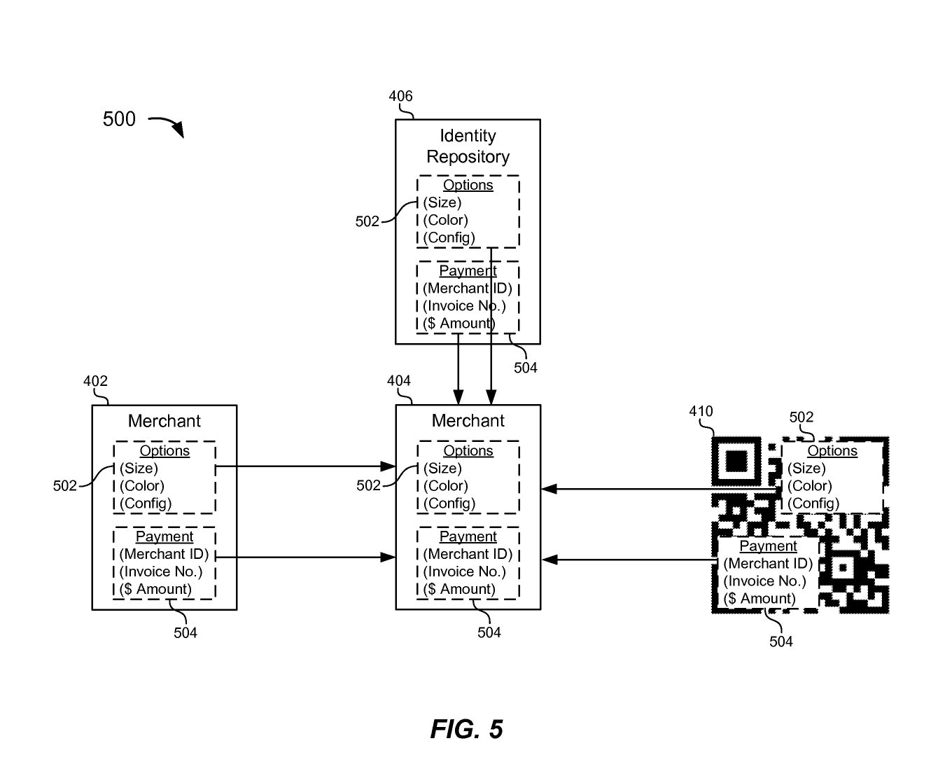

FIG. 5 illustrates a simplified block diagram 500 for accessing payment information, according to one embodiment. As described above, product option types may be associated with the product being purchased. As used herein, a product may also include services. Product option types may include pricing options, size options, color options, hardware configurations, add-ons, coupon options, and/or the like. In order to complete a purchase and make a proper payment, a selection may need to be made for each of the product option types.

In some embodiments, the user device may 404 may access product option types for the product being purchased. FIG. 5 illustrates that the product option types 502 may be stored in various locations, depending on the particular embodiment. In one embodiment, the product option types 502 may be encoded in the encoded graphic 410. When the user device 404 decodes the information from the encoded graphic 410, product option types 502 may be accessed by the user device.

In some embodiments, the product option types 502 may be stored in a memory location on the user device 404. For example, a cookie or other identifier may be stored on the user device 404 that includes a lookup table. An identifier retrieved from the encoded graphic 410 may be used to access a set of product option types 502 from the local table storage on the user device 404.

In some embodiments, the product option types 502 may be stored at the merchant 402. It will be understood, that the term merchant may also be used to refer to a merchant device, or a computing device operated by the merchant 402. In these embodiments, the user device 404 may retrieve a merchant identifier or URI from the encoded graphic 410 and retrieve the product option types from the merchant 402.

In some embodiments, the product option types 502 may be stored at the identity repository 406. As part of registering with the identity repository 406, the merchant 402 may provide a list of product option types associated with each product available for sale from the merchant 402. A merchant identifier retrieved from the encoded graphic 410 may be sent to the identity repository 406 and used to retrieve the previously-stored set of product auction types 502.

Block diagram 500 also shows that additional payment information 504 may be stored in various locations in a manner similar to the product option types 502. For example a bill comprising the encoded graphic 410 may have the invoice number, payment amount, etc., stored as part of the encoded graphic 410. Alternatively, this information could be looked up in an account on the user device 404, retrieved from the merchant 402, or retrieved from the identity repository 406. For example, the merchant 402 could register invoices with the identity repository 406. The user device 404 could retrieve a merchant ID or invoice number from the encoded graphic 410, and request the information from the invoice from the identity repository 406.

In some embodiments, the methods and locations for storing the payment information 504 and the product option types 502 described above may be combined in various ways. For example, product option types 502 may be stored in multiple locations, and accessed depending on which location is most readily available. Regardless of where the payment information 504 and/or the product option types 502 are stored, they may both be retrieved using information associated with the encoded graphic 410. Therefore, regardless of where the payment information 504 stored, the user device 404 may determine the payment information using information associated with the encoded graphic 410.

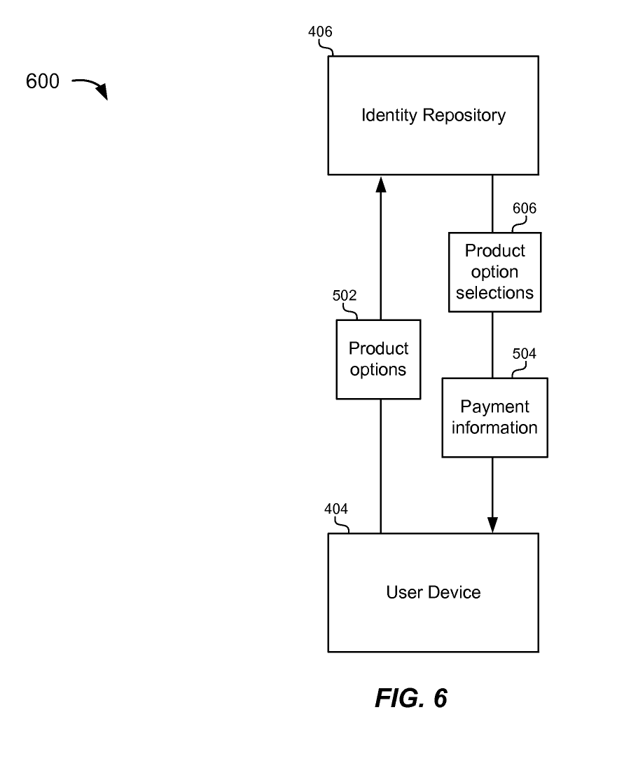

FIG. 6 illustrates a simplified block diagram 600 for specifying product option selections, according to one embodiment. As used herein, a product option selection may refer to a particular value related to a product option type. For example, if a product option type comprises a size, then a product option selection may comprise a size value, such as large, medium, or small. Users may find it useful to store product option selections so that they do not need to be entered every time a purchase is made. In some embodiments, users may store shoe sizes, dress sizes, shirt sizes, preferred colors, preferred hardware configurations, and/or the like, so the selections may be automatically applied to purchases made in the future. This may reduce data entry errors during purchasing, and may simplify purchasing processes for users.

In some embodiments, the product option selections may be stored locally on the user device 404. However, in other embodiments, product option selections may be stored at the identity repository 406. In cases where the product option selections are stored at the identity repository 406, the user device 404 may request the product option selections 606 from the identity repository 406. For example, the user device 404 could send the product option types 502 to the identity repository 406.

In some embodiments, the identity repository 406 may store personal information in an encrypted form. For example, information could be stored as encrypted key/value pairs. Therefore, each of the product option types 502 could be encrypted using a private key on the user device 402 and sent to the identity repository 406. The identity repository 406 could then use the encrypted product option types 502 to look up the encrypted selections for each type in a dictionary-type data structure. The encrypted product option selections 606 could then be sent to the user device 404 and decrypted there using the private key of the user device 404.

In some embodiments, the user may be presented with the product option selections 606 that were previously stored. The user may then be given the opportunity to override any of the product option selections 606 for the particular purchase. For example, a user could choose a different color product than their preferred color stored at the identity repository 406. In other cases, the identity repository 406 may not include a selection for a particular product option type. In this case, the user may be prompted to enter a selection and may be presented with possible values for the product option type, such as large, medium, and small.

Similarly, payment information 504 may also be retrieved from the identity repository 406. In some cases, a preferred payment method may be retrieved, such as a particular credit card account, or a particular bank account. In some cases, an account number of the preferred payment method may be retrieved as well. This may reduce the need for users to enter in their account number for each purchase, without requiring users to store account numbers locally on the user device 404 or at the merchant, both of which are easily compromised. As with the product option selections 606, the user may be presented with the preferred payment method, and may be given the opportunity to override this default value with a different payment method. In embodiments where the identity repository 406 is encrypted, the account number and/or preferred payment method may be returned to the user device 404 in an encrypted form, and decrypted using a private key of the user device 404.

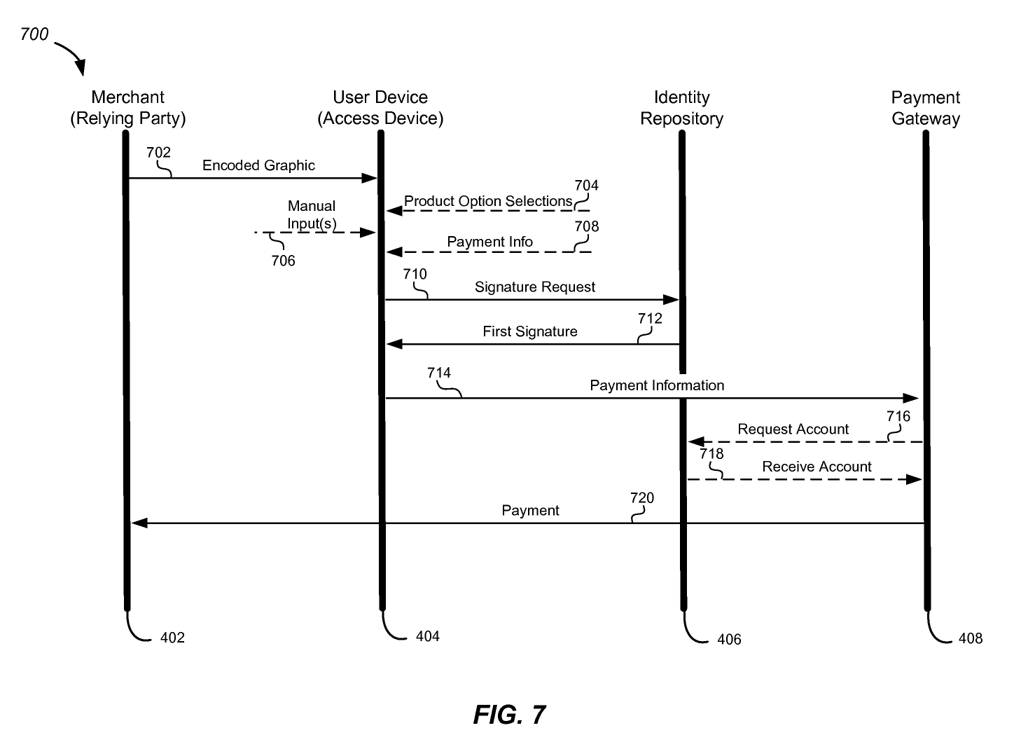

FIG. 7 illustrates a simplified flow diagram 700 of transactions involving an encoded graphic, according to one embodiment. Flow diagram 700 is merely exemplary of transactions as they may flow in one embodiment. In other embodiments, transactions may be added, removed, modified, combined, or divided into sub transactions. Therefore, FIG. 7 is not meant to be limiting.

The merchant 402 may provide an encoded graphic that may be accessible to a user device 404 (702). The encoded graphic may be sent in the mail, transmitted electronically, publicly displayed, and/or the like. The user device 404 may acquire an image of the encoded graphic. Depending on the particular embodiment, the user device 404 may receive manual inputs from user (706). The user device 404 may also receive product selection options (704) and/or payment information (708) that is stored locally, retrieved from another device and/or decoded from the encoded graphic. The product selection options and/or payment information may be determined using information associated with the encoded graphic, such as information decoded from the encoded graphic.

The user device 404 may send the signature request to the identity repository 406 (710). In some embodiments, the identity repository 406 may respond by sending a challenge to the user device 404 that can be signed using a PIN, a password, a salt value, and/or the like. In other embodiments, the identity repository 406 may receive a challenge generated by the user device that is acceptable to the identity repository, such as a time and/or date stamped value. The signed challenge can be used by the identity repository 406 to verify an identity associated with the user device 404, such as a device ID, or a user ID.

The identity repository 406 may make determinations as to whether it should provide the requested signature. These determinations may be based on the signed challenge received from the user device 404. These determinations may also be based on user preferences stored at the identity repository 406. These determinations may also be based on default values provided by the identity repository 406. These determinations may also be based on the payment information and/or product option types/selections.

For example, a risk level may be determined for the transaction. The risk level may be based on a user device type, a merchant type, the purchase amount, a purchase item type, and/or the like. A user profile setting or a default repository value may dictate that transactions below a certain risk level threshold may be signed if the device identifier is verified. Transactions above the certain risk level threshold may require additional user authorizations, such as an out-of-band (OOB) verification using a control device. The type of verification may also be set by the merchant and/or the payment gateway. As described above, different levels of assurance (LoA) may be specified for a single transaction, and the identity repository 406 may choose the most secure or restrictive LoA from those active in the transaction. Therefore, the identity repository 406 may enforce the LoAs from the merchant 402, the user device 404, the identity repository 406, and/or the payment gateway 408. In short, any of the verification and LoA techniques described above in relation to the identity management system may be used by the identity repository 406 when determining whether to provide a signature.

If the identity repository 406 determines that a signature should be provided, the identity repository signature, referred to herein occasionally as the first signature, may be transmitted to the user device 712. At this point, the user device 404 may also provide a signature using a private key associated with a virtual identity and stored on the user device 404. This may be referred to herein as a second signature. Note that some embodiments do not require a second signature, while other embodiments do require a second signature. The payment information may be compiled to include information decoded from the encoded graphic, information stored locally on the user device 404, and/or information retrieved from the identity repository 406. The payment information, the first signature, and the second signature may be transmitted to a payment gateway 408 for payment.

After receiving the signatures and payment information, the payment gateway 408 may request additional information from the identity repository 406. Note that in some embodiments, the payment information sent from the user device 404 may be sufficient to complete the payment. In some cases this may include an account number in the payment information. In other embodiments, an account number may be stored in an encrypted format at the identity repository 406, and may need to be retrieved by the payment gateway 408. In these embodiments, the payment gateway may request an account number from the identity repository 406 (716). The identity repository may determine whether the request is authenticated, valid, and/or matches a transaction approved by the user device 404. In response, the identity repository may send an account number to the payment gateway 408 (716). The payment gateway 408 may process the payment information as an ACH transaction, a credit card transaction, and/or the like. An indication that payment was successful may be sent to the merchant 402 (720).

During these transactions, the user device 404 may be configured to use a software application that is provided by an operator of the identity repository. For example, the user device 404 may comprise a smart phone, and may download an identity repository “app” from an online app store, such as the Apple Store®. The app operating on the user device may cause the user device to engage in one side of the transactions depicted above.

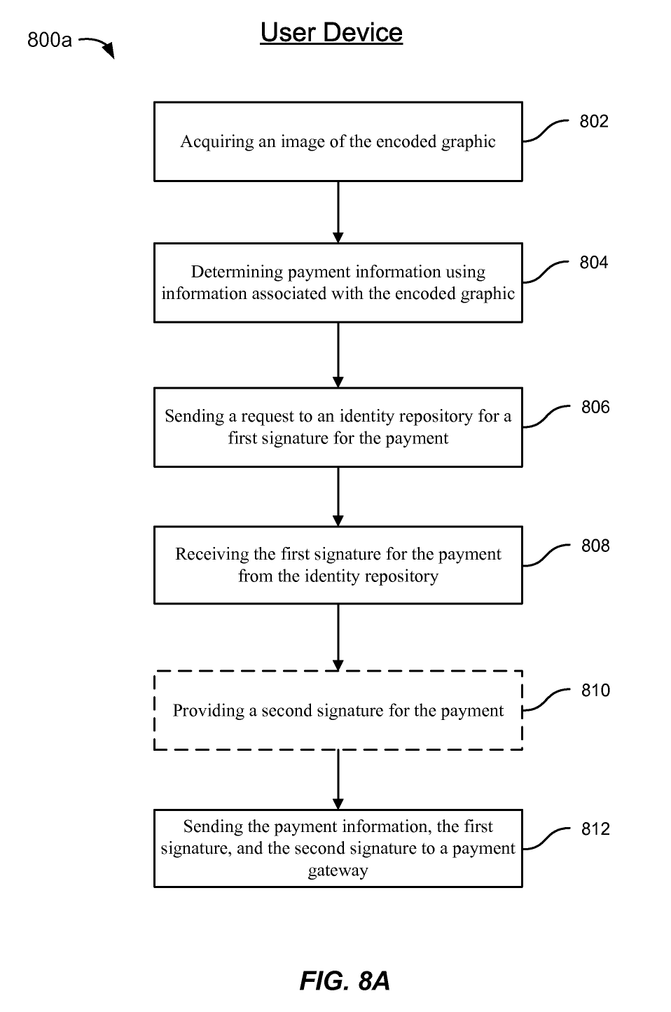

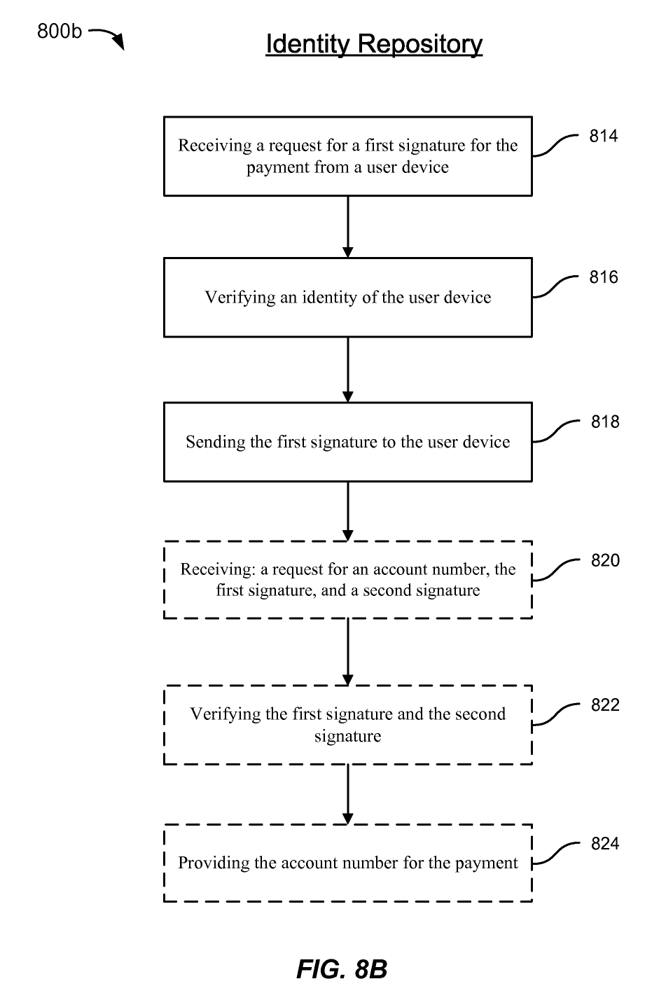

FIG. 8A illustrates a simplified flowchart 800a of a method of making a payment involving an encoded graphic by a user device, according to one embodiment. The method may include acquiring an image of the encoded graphic (802). The encoded graphic may be obtained using a camera, or any other type of input device as described above. In one embodiment, the encoded graphic may comprise a Quick Response (QR) code.

The method may also include determining payment information using information associated with the encoded graphic (804). In some embodiments, information associated with the encoded graphic may include information decoded from the encoded graphic, such as a merchant identifier, an invoice number, a transaction ID, a customer ID, and/or the like. The information associated with the encoded graphic made be part of the payment information determined. For example, a merchant ID may be both associated with the encoded graphic and included in the payment information.

The information associated with the encoded graphic may be used to determine additional payment information. For example, information decoded from the encoded graphic may be used to look up additional transaction details such as a payment amount, the transaction type, a product purchased, a bill number, an invoice number, and/or the like. The additional payment information may be determined by requesting such from a merchant website, the identity repository, or local storage on the user device. In some embodiments, payment information may also be determined by presenting the information associated with the encoded graphic to the user and receiving user input in response.

In some embodiments, the user device may also access product option types for a product being purchased. Like the payment information, the product option types may be accessed using information decoded from the encoded graphic, and/or may be retrieved from the encoded graphic, from the user device, from a merchant device, from the identity repository, and/or the like. In some embodiments, product option selections may be solicited from the user and received using an input device.

The method may also include sending a request to an identity repository for a first signature for the payment (806). In some embodiments, the request may include some or all of the payment information such that the identity repository may determine whether or not to provide a signature. In some embodiments, the request may also be accompanied by requests for product option selections, or additional payment information, such as a payment method.

The method may also include receiving the first signature for the payment from the identity repository (808). The first signature may indicate that the identity repository has approved the transaction and will release an account number to a payment gateway. The first signature may also indicate that the identity repository has enforced any LoA requirements specified by one or more of the parties involved in the transaction.

In some embodiments, the first signature may also be accompanied by product option selections and/or additional payment information. The product option selections and/or additional payment information may be received in an encrypted form, and may be decrypted using a private key stored on the user device. The product option types and the request for additional payment information may be in the form of encrypted field names, and the resulting product option selections and additional payment information may be in the form of encrypted values. Thus, only values specifically requested by the user device may need to be sent from the identity repository, although other values may be sent as well.

The method may also include providing a second signature for the payment (810). The second signature may be provided by the access device. Note that some embodiments do require a second signature, while other embodiments do not require a second signature. The second signature may be granted in response to a user input authorizing the transaction and/or verifying the identity of the user.

The method may further include sending the payment information, the first signature, and/or the second signature to a payment gateway (812). In some embodiments, the payment gateway may request additional information from the user device if needed. For example, the payment gateway may request an unencrypted version of an account number. In some embodiments, the payment information and signatures may be sent to the payment gateway by way of either the merchant device or the identity repository.

FIG. 8B illustrates a simplified flowchart 800b of a method of authorizing a payment involving an encoded graphic, according to one embodiment. This method may be carried out from the perspective of the identity repository in some embodiments. The method may include receiving a request for a first signature for the payment from a user device (814). As described above, the request for the first signature may include payment information and/or product option types.

In some embodiments, the identity repository may verify information before providing a signature. For example, the identity repository may verify a device ID, a user ID, and/or any other identifier used to prove an identity of a device or user. Also, the identity repository may require additional authentications/authorizations depending on the LoA required for the transaction.

If the identity repository determines that the first signature should be provided, then the method may also include sending the first signature to the user device (818). The first signature may be sent with additional encrypted information, such as encrypted values corresponding to encrypted fields sent from the user device.

In some embodiments, providing the first signature may end the identity repository's involvement in the transaction. In other embodiments, the method may further include receiving a request for an account number (820). This request may be accompanied by the first signature and a second signature from a user device. This request may be sent from the merchant device, the user device, and/or the payment gateway. The identity repository may verify the first signature, and/or the second signature using public keys that correspond to the private keys with which they were signed (822). If the signatures are verified, and/or the LoA requirements have been met, the identity repository may provide the account number for the payment (824). In some embodiments, the account number may be transmitted in an encrypted form to be decrypted away from the identity repository.

In some embodiments, the request for an account number may be part of the request for the first signature. In these cases, the identity repository need not verify the first signature or the second signature. For example, the user device could request the account number before the first signature and/or the second signature are obtained. Instead, the identity repository may verify the identity of the user device and/or the user.

Turning back briefly to FIG. 2, each of the methods and systems described herein for using an encoded graphic to make a payment may be implemented using the identity management system. For example, the relying party or resource may comprise the website, merchant device, or merchant. The access device may comprise the user device. The identity repository described in this section may also operate according to any of the features described for the identity repository described in relation to FIG. 1 and FIG. 2. Therefore, any of the methods related to secure online identity management, such as PIN verification, transaction signatures, distributed secrets, device verification, OOB verification, and/or the like, may be used to augment any of the method steps described in relation to FIG. 8A and FIG. 8B. Any of these method steps may be performed in any order, and may be rearranged, combined, subdivided, and carried out on multiple devices. Flowchart 800a and flowchart 800b are merely exemplary, and not meant to be limiting.

### Exemplary Hardware

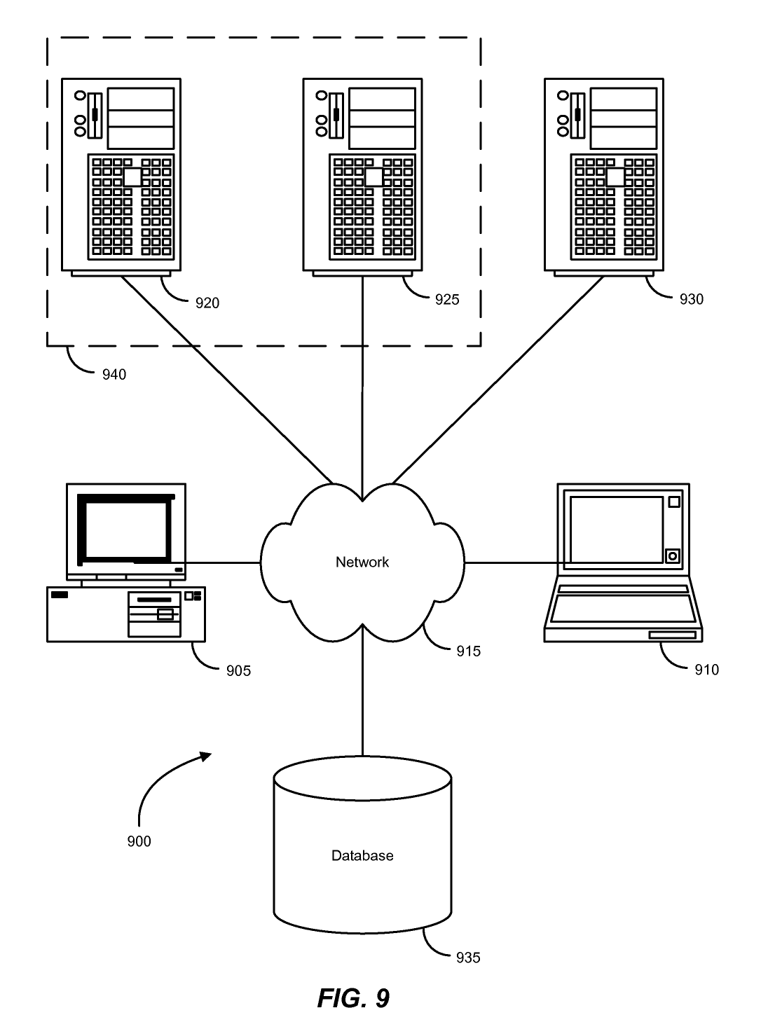

Each of the embodiments disclosed herein may be implemented in one or more computer systems. The computer systems can communicate with each other through a network. FIG. 9 is a block diagram illustrating components of an exemplary operating environment in which various embodiments of the present invention may be implemented. The system 900 can include one or more user computers 905, 910, which may be used to operate a client, whether a dedicated application, web browser, etc. The user computers 905, 910 can be general-purpose personal computers (including, merely by way of example, personal computers and/or laptop computers running various versions of Microsoft Corp.'s Windows and/or Apple Corp.'s Macintosh operating systems) and/or workstation computers running any of a variety of commercially-available UNIX or UNIX-like operating systems (including without limitation, the variety of GNU/Linux operating systems). These user computers 905, 910 may also have any of a variety of applications, including one or more development systems, database client and/or server applications, and web browser applications. Alternatively, the user computers 905, 910 may be any other electronic device, such as a thin-client computer, Internet-enabled mobile telephone, and/or personal digital assistant, capable of communicating via a network (e.g., the network 915 described below) and/or displaying and navigating web pages or other types of electronic documents. Although the exemplary system 900 is shown with two user computers, any number of user computers may be supported.

In some embodiments, the system 900 may also include a network 915. The network may can be any type of network familiar to those skilled in the art that can support data communications using any of a variety of commercially-available protocols, including without limitation TCP/IP, SNA, IPX, AppleTalk, and the like. Merely by way of example, the network 915 may be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks such as GSM, GPRS, EDGE, UMTS, 3G, 2.5 G, CDMA, CDMA2000, WCDMA, EVDO etc.

The system may also include one or more server computers 920, 925, 930 which can be general-purpose computers and/or specialized server computers (including, merely by way of example, PC servers, UNIX servers, mid-range servers, mainframe computers rack-mounted servers, etc.). One or more of the servers (e.g., 930) may be dedicated to running applications, such as a business application, a web server, application server, etc. Such servers may be used to process requests from user computers 905, 910. The applications can also include any number of applications for controlling access to resources of the servers 920, 925, 930.

The web server can be running an operating system including any of those discussed above, as well as any commercially-available server operating systems. The web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 905, 910. As one example, a server may execute one or more web applications. The web application may be implemented as one or more scripts or programs written in any programming language, such as Java™, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 905, 910.

In some embodiments, an application server may create web pages dynamically for displaying on an end-user (client) system. The web pages created by the web application server may be forwarded to a user computer 905 via a web server. Similarly, the web server can receive web page requests and/or input data from a user computer and can forward the web page requests and/or input data to an application and/or a database server. Those skilled in the art will recognize that the functions described with respect to various types of servers may be performed by a single server and/or a plurality of specialized servers, depending on implementation-specific needs and parameters.

The system 900 may also include one or more databases 935. The database(s) 935 may reside in a variety of locations. By way of example, a database 935 may reside on a storage medium local to (and/or resident in) one or more of the computers 905, 910, 915, 925, 930. Alternatively, it may be remote from any or all of the computers 905, 910, 915, 925, 930, and/or in communication (e.g., via the network 920) with one or more of these. In a particular set of embodiments, the database 935 may reside in a storage-area network (“SAN”) familiar to those skilled in the art. Similarly, any necessary files for performing the functions attributed to the computers 905, 910, 915, 925, 930 may be stored locally on the respective computer and/or remotely, as appropriate. In one set of embodiments, the database 935 may be a relational database, such as Oracle 10g, that is adapted to store, update, and retrieve data in response to SQL-formatted commands.

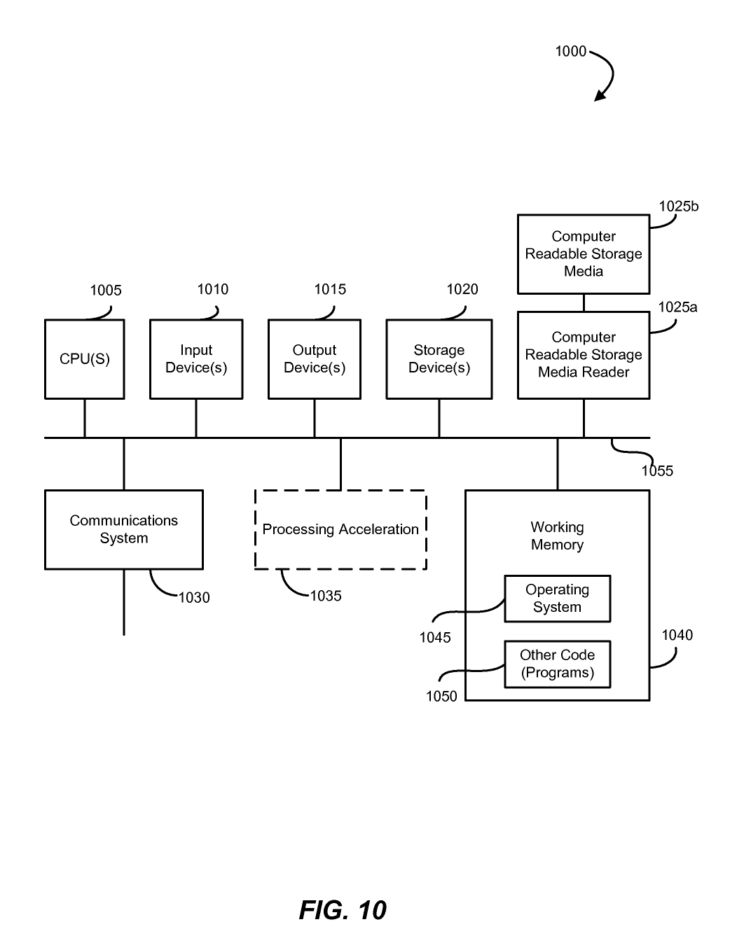

FIG. 10 illustrates an exemplary computer system 1000, in which various embodiments of the present invention may be implemented. The system 1000 may be used to implement any of the computer systems described above. The computer system 1000 is shown comprising hardware elements that may be electrically coupled via a bus 1055. The hardware elements may include one or more central processing units (CPUs) 1005, one or more input devices 1010 (e.g., a mouse, a keyboard, etc.), and one or more output devices 1015 (e.g., a display device, a printer, etc.). The computer system 1000 may also include one or more storage device 1020. By way of example, storage device(s) 1020 may be disk drives, optical storage devices, solid-state storage device such as a random access memory (“RAM”) and/or a read-only memory (“ROM”), which can be programmable, flash-updateable and/or the like.

The computer system 1000 may additionally include a computer-readable storage media reader 1025a, a communications system 1030 (e.g., a modem, a network card (wireless or wired), an infra-red communication device, etc.), and working memory 1040, which may include RAM and ROM devices as described above. In some embodiments, the computer system 1000 may also include a processing acceleration unit 1035, which can include a DSP, a special-purpose processor and/or the like.

The computer-readable storage media reader 1025a can further be connected to a computer-readable storage medium 1025b, together (and, optionally, in combination with storage device(s) 1020) comprehensively representing remote, local, fixed, and/or removable storage devices plus storage media for temporarily and/or more permanently containing computer-readable information. The communications system 1030 may permit data to be exchanged with the network 1020 and/or any other computer described above with respect to the system 1000.

The computer system 1000 may also comprise software elements, shown as being currently located within a working memory 1040, including an operating system 1045 and/or other code 1050, such as an application program (which may be a client application, web browser, mid-tier application, RDBMS, etc.). It should be appreciated that alternate embodiments of a computer system 1000 may have numerous variations from that described above. For example, customized hardware might also be used and/or particular elements might be implemented in hardware, software (including portable software, such as applets), or both. Further, connection to other computing devices such as network input/output devices may be employed. Software of computer system 1000 may include code 1050 for implementing embodiments of the present invention as described herein.

The following methods may be implemented by a computer system, such as computer system 1000 in FIG. 10. Each step of these methods may be done automatically by the computer system, and/or may be provided as inputs and/or outputs to a user. For example, a user may provide inputs for each step in a method, and each of these inputs may be in response to a specific output requesting such an input, wherein the output is generated by the computer system. Each input may be received in response to a corresponding requesting output. Furthermore, inputs may be received from a user, from another computer system as a data stream, retrieved from a memory location, retrieved over a network, requested from a web service, and/or the like. Likewise, outputs may be provided to a user, to another computer system as a data stream, saved in a memory location, sent over a network, provided to a web service, and/or the like. In short, each step of the methods described herein may be performed by a computer system, and may involve any number of inputs, outputs, and/or requests to and from the computer system which may or may not involve a user. Therefore, it will be understood in light of this disclosure, that each step and each method described herein may be altered to include an input and output to and from a user, or may be done automatically by a computer system.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

What is claimed is:

1. A method of making a payment using an encoded graphic by a user device, the method comprising:
acquiring an image of the encoded graphic;
determining payment information using information associated with the encoded graphic;
sending a request to an identity repository for a first signature for the payment;
receiving the first signature for the payment from the identity repository; and
sending the payment information and the first signature to a payment gateway.

2. The method of claim 1 further comprising:
providing, by the user device, a second signature for the payment; and
sending the second signature to the payment gateway.

3. The method of claim 1 wherein the encoded graphic comprises a Quick Response (QR) code.

4. The method of claim 1 wherein the first signature indicates that the identity repository has verified an identity of the user device.

5. The method of claim 1 wherein determining payment information using the information associated with the encoded graphic comprises:
decoding a merchant identifier from the encoded graphic; and
using the merchant identifier to retrieve a payment amount, wherein the payment information comprises the payment amount.

6. The method of claim 5 wherein determining payment information using the information associated with the encoded graphic comprises:
decoding an invoice identifier from the encoded graphic; and
using the invoice identifier to retrieve the payment amount.

7. The method of claim 1 further comprising receiving a payment method, wherein the payment information comprises the payment method.

8. The method of claim 7 wherein the identity repository is authorized to release an account number for the payment method.

9. The method of claim 1 further comprising:
accessing product option types for a product being purchased;
sending the identity repository a request for product option selections; and
receiving the product option selections from the identity repository, wherein the payment information comprises the product option selections.

10. The method of claim 9 wherein the product option types are decoded from the encoded graphic.

11. The method of claim 1 wherein the payment information is sent to the payment gateway through the identity repository.

12. A method of authorizing a payment involving an encoded graphic by an identity repository, the method comprising:
receiving a request for a first signature for the payment from a user device;
verifying an identity of the user device;
sending the first signature to the user device;
receiving a request for an account number; and
providing the account number for the payment.

13. The method of claim 12 wherein the request for the account number comprises a second signature that is signed by the user device.

14. The method of claim 12 wherein the account number is provided to a payment gateway.

15. The method of claim 12 further comprising:
receiving product option types for a product being purchased; and
providing product option selections corresponding to the product option types, wherein the product option selections are stored in an encrypted form at the identity repository.

16. The method of claim 15 wherein the product option selections were previously provided to the identity repository by the user device.

17. The method of claim 12 further comprising receiving a signed challenge from the user device in order to verify the identity of the user device.

18. The method of claim 12 further comprising:
receiving a merchant identifier from the user device, wherein the merchant identifier is decoded from the encoded graphic;
retrieving payment information using the merchant identifier; and
sending the payment information to the user device.

19. The method of claim 12 wherein:
the identity repository is geographically remote from the user device;
the identity repository stores information provided by the user device in an encrypted form; and
a decryption key associated with the information provided by the user device is not stored in the identity repository.

20. A computer-readable memory comprising a sequence of instructions which, when executed by one or more processors, causes the one or more processors to make a payment using an encoded graphic by:
acquiring an image of the encoded graphic;
determining payment information from the encoded graphic;
sending a request to an identity repository for a first signature for the payment;
receiving the first signature for the payment from the identity repository; and
sending the payment information and the first signature to a payment gateway.
